(19) United States
(12) Patent Application Publication
(10) Pub. No.: US 2018/0232496 A1
(43) Pub. Date: Aug. 16, 2018

(54) METHOD AND SYSTEM FOR PERSONALIZING DRUG DOSAGES

(71) Applicant: eBroselow, LLC, Blacksburg, VA (US)

(72) Inventor: James B. Broselow, Hickory, NC (US)

(21) Appl. No.: 15/432,365

(22) Filed: Feb. 14, 2017

(51) Int. Cl. G06F 19/00

(52) U.S. Cl. CPC G06F 19/3456; G06F 19/326

(57) ABSTRACT

A method of personalizing drug dosages that includes the steps of analyzing and correlating a plurality of patient health condition factors specific to a particular patient with a database of drugs that includes drug dosage specifications and individual drug dosage adjustments based on the plurality of patient health condition factors. A code segment is generated for each of the plurality of patient health condition factors specific to the particular patient and assigning the plurality of code segments to the particular patient, and the plurality of code segments is digitized and stored for retrieval. Upon presentation of a drug prescription, the digitized plurality reads the code segments, accesses the drug database and adjusts the drug dosage as indicated by the drug database.

### TECHNICAL FIELD AND BACKGROUND OF THE INVENTION

This invention relates to a method to digitalize, and thus automate, the personalization of medication drug ordering, prescribing and administration practices and a computer system for storing, retrieving and displaying adjustments to drug dosages based on computer-derived drug dosage information. For many young and healthy adults, the prescribing and administering of medications is standardized. The dose, frequency, dilution, etc., are identical so that the only consideration is where along the spectrum of the medication potency the drug should be ordered. For instance, a blood pressure medication with a range of 25-50 mgs. administered 2-3 times a day maybe initially ordered at the low end and then titrated to clinical effect while being monitored at home or in the office.

However, patient-specific factors can greatly influence the safety and/or efficacy of any prescription and should be taken into account whenever medications are being prescribed. For instance, as a patient ages, the absorption or rate of elimination of certain drugs may change even in the absence of any gastrointestinal, liver or renal disease. Thus, a dose that is average in potency for a younger adult might be quite high or even toxic for older patients. Or a drug that is ordered three times a day for the standard patient might need to be ordered only once a day if aging or disease has adversely affected a patient's kidney or liver function. Finally, there are certain drugs whose metabolism varies from patient-to-patient according to the genomics of each patient, at times requiring higher than normal dose, while in other patients requiring reduced dosing.

Over time, the complexity of prescribing and delivering medications has increased exponentially due to the increasing number and indications of drugs. Also, the change in medical practice from a primary physician who was taught to “know a few drugs well and order them for their patients” is no longer possible with the transition of care from offices, to specialists, to emergency rooms and hospitals all treating the same patient.

With the time restrictions of modern medicine, it is virtually impossible for a prescribing practitioner to be familiar with all of the nuances of every drug, as well as, to thoroughly review each patient's record to write an appropriate patient-specific prescription. In addition, even if the knowledge is present, the clinician must take all of this information into account to order the prescription safely. Clearly, there are large areas for mistakes to occur at each step of this process, and the ability to automate as much of the prescribing and administration functions as possible would be a huge advance in medication safety.

Recent advances in medication administration systems see for example, U.S. Pat. Nos. 8,494,875; 8,676,602; U.S. Pub. Appln. Nos. 2007/0061164 and 2010/0057488, the disclosure of each of which is incorporated by reference, allow access to granular, digitized medication information rather than in previous pdf-type formats. A digitized type of system, for example, the well-known “eBroselow” drug database system, has the potential to apply variables for safe personalized prescribing and administration, including dose and frequency and to permit the information to be accessed from a database to generate patient-specific process dosing and administration information. In essence, such a system could be “filtered” so that all of the information displayed would match the requirements of a specific patient.

To complete the process, each patient must have an alphanumerical code that communicates to the database the exact changes needed to accommodate the patient's particularized health condition. Such a code would need to include individual segments addressing at least the patient's age, renal and liver function as well as any relevant genetic variations related to drug metabolism. This code, for instance, could be a barcode that the patient carries, which if scanned into a digital medication system as described below would personalize each step in the medication prescribing and administration process.

At present, there is no known database of drugs that contains a comprehensive listing of drug dosage adjustments based on patient health conditions, nor is there a known database of drugs that can determine a correct drug dosage based on a plurality of patient health conditions in the aggregate.

### SUMMARY OF THE INVENTION

It is therefore an object of the present invention to provide a method of personalizing drug dosages.

It is another object of the invention to provide a method of taking into account various factors that affect how a specific patient reacts to a drug dosage.

It is another object of the invention to provide a method of correlating various factors that affect how a specific patient reacts to a drug dosage and applying those factors to, for example, a card that can be used by medical personnel when treating a patient with drugs.

It is another object of the invention to provide a method of correlating various factors that affect how a specific patient reacts to a drug dosage and to convert those factors to a series of code segments that in the aggregate permits an adjustment of a standard drug dosage to take into account those factors.

According to one preferred embodiment of the invention, a method of personalizing drug dosages includes the steps of analyzing and correlating a plurality of patient health condition factors specific to a particular patient with a database of drugs that includes drug dosage specifications and individual drug dosage adjustments based on the plurality of patient health condition factors and generating a code segment for each of the plurality of patient health condition factors specific to the particular patient and assigning the plurality of code segments to the particular patient. The plurality of code segments is digitized and the digitized plurality of code segments is stored for retrieval. Upon presentation of a code segment for each of the plurality of patient health condition factors specific to the particular patient, the stored digitized plurality of code segments is retrieved and the plurality of code segments specific to the particular patient is read. The drug database is accessed and the stored digitized plurality of code segments is correlated with the plurality of code segments specific to the particular patient. The drug dosage is adjusted as indicated by the output of the drug database, allowing the practitioner to prescribe or administer a customized dosage.

According to another preferred embodiment of the invention, the plurality of patient health condition factors comprise age, renal, liver, genomic and allergy.

According to another preferred embodiment of the invention, the method includes the step of determining an adjustment of a drug dosage based on the plurality of patient health condition factors in the aggregate.

According to another preferred embodiment of the invention, the step of generating a code for each of the plurality of patient health condition factors includes the step of assigning an arbitrary value to each of the plurality of factors independent of any other ones of the plurality of factors.

According to another preferred embodiment of the invention, at least one of the plurality of patient health condition factors is a single factor that alone results in a rejection of the proposed drug.

According to another preferred embodiment of the invention, a computer-assisted system for personalizing drug dosages is provided and includes the steps of storing in a digital processor data identifying a plurality of drugs, drug dosage specifications and individual drug dosage adjustments based on a plurality of patient health condition factors and digitizing a plurality of code segments correlated to the plurality of drugs, drug dosage specifications and individual drug dosage adjustments based on a plurality of patient health condition factors and storing the digitized plurality of code segments in the digital processor for retrieval. A code segment for each of the plurality of patient health condition factors specific to a particular patient is received at the digital processor and the digital processor correlates the plurality of patient health condition factors specific to a particular patient with the stored digital data identifying a plurality of drugs, drug dosage specifications and individual drug dosage adjustments based on the code segments relating to the plurality of patient health condition factors. The digital processor outputs an adjusted drug dosage based on the correlation.

According to another preferred embodiment of the invention, a method utilizing a computer-assisted system for personalizing drug dosages is provided that includes the steps of storing in a digital processor data identifying a plurality of drugs, drug dosage specifications and individual drug dosage adjustments based on a plurality of patient health condition factors and digitizing a plurality of code segments correlated to the plurality of drugs, drug dosage specifications and individual drug dosage adjustments based on a plurality of patient health condition factors and storing the digitized plurality of code segments in the digital processor for retrieval. A code segment for each of the plurality of patient health condition factors specific to a particular patient is received at the digital processor, wherein the plurality of patient health condition factors comprise age, renal, liver, genomic and allergy factors. In the digital processor, an arbitrary value is assigned to each of the plurality of factors independent of any other ones of the plurality of factors. In the digital processor, the plurality of patient health condition factors specific to a particular patient is correlated with the stored digital data identifying a plurality of drugs, drug dosage specifications and individual drug dosage adjustments based on the code segments relating to the plurality of patient health condition factors, wherein the digital processor determines an adjustment of a drug dosage based on the plurality of patient health condition factors in the aggregate. The digital processor outputs an adjusted drug dosage based on the correlation.

According to another preferred embodiment of the invention, at least one of the plurality of patient health condition factors is stored in the digital processor as a single factor that alone results in a rejection of the proposed drug.

According to another preferred embodiment of the invention, the digital processor correlates the plurality of patient health condition factors specific to a particular patient with the stored digital data identifying a plurality of drugs, drug dosage specifications and individual drug dosage adjustments based on the code segments relating to the plurality of patient health condition factors, wherein the digital processor determines a drug dosage based on the plurality of patient health condition factors in the aggregate.

### BRIEF DESCRIPTION OF THE DRAWING FIGURES

The present invention is best understood when the following detailed description of the invention is read with reference to the accompanying drawings, in which:

FIG. 1 is a flow diagram of a manner in which various factors can be analyzed and filtered to correlate to a specific patient; and

FIG. 2 is a flow diagram of a method of personalizing drug dosages according to one embodiment of the invention.

### DETAILED DESCRIPTION OF THE PREFERRED EMBODIMENT

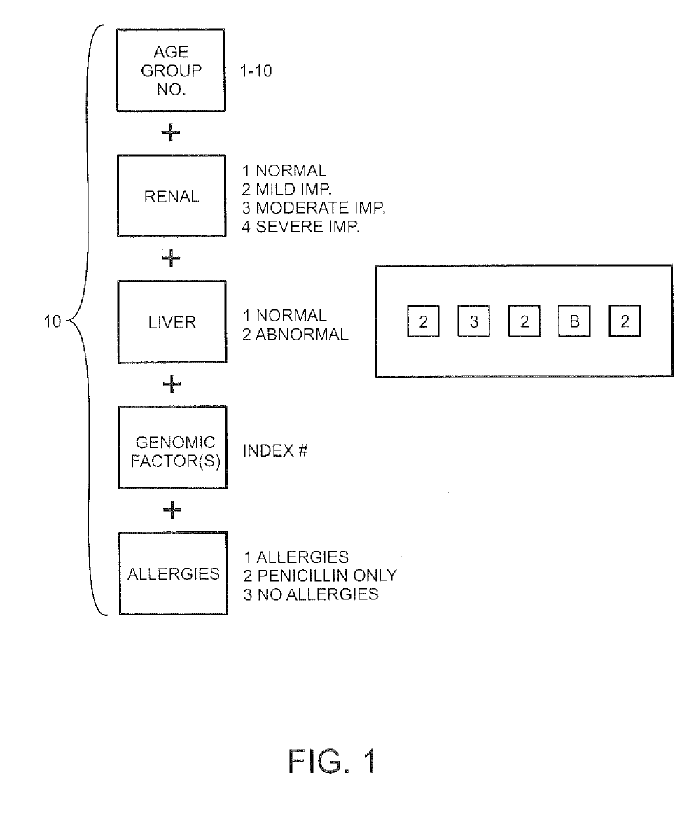

Referring now to the drawings, FIG. 1 illustrates that the method can begin with an analysis of the health and physical condition of a patient, as noted at reference numeral 10. Various factors may be taken into account. As shown at 10, the factors may include age; renal (kidney) and liver function, genomic factors that may affect metabolism and other body functions and allergies. These factors where appropriate are divided into gradations. For example, patient age can be divided into age ranges from neonates to the elderly. Renal function can be determined by conventional tests and can then be divided into ranges such as, “normal”, “mild impairment” and so forth. Similarly, liver function can be determined by conventional tests and divided into ranges similar to the renal function ranges or more simply into “normal” and “abnormal.” Because various genomic factors can affect the manner in which drugs interact with a patient, such factors should be taken into account, as well.

Penicillin allergies are quite common and so a person with such an allergy should be noted as such.

Each of these above-referenced factors is provided with a number as a discrete identifier and for each patient the discrete identifier is placed onto a card, sticker or other device, which may be a current or future digital device that can then be associated with the patient. The card, sticker or other device that contains code segments representing the factors taken into account can then be used by a practitioner to prescribe or administer a drug with a dosage customized to that particular patient. The information is digitally transferred into a granular database that has the capability to individually modify the various aspects regarding the preparation and administration of drugs to meet the individual needs of the patient, including dose, frequency, volume and the like.

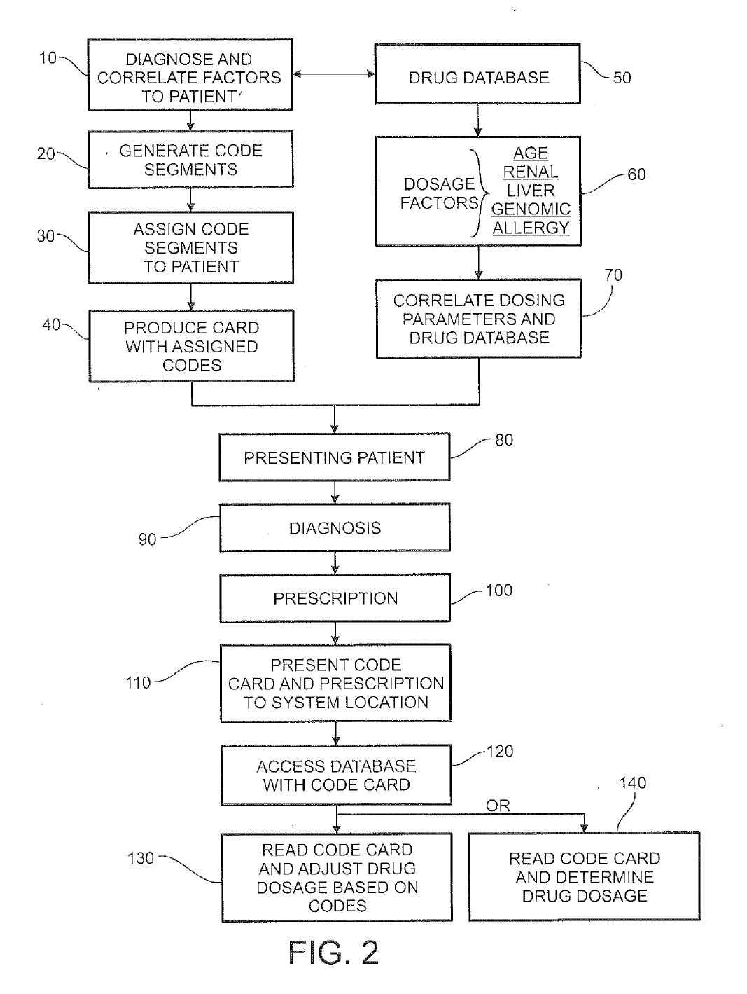

More specifically, the analysis shown in FIG. 2 at reference numeral 10 is indicated as one of two starting points and is used to generate a code segments 20 specific to the patient, also shown in FIG. 1. The code segments are assigned to a patient 30 and the code segments are documented in some manner, 40, as on a card, bar code sticker, memory chip or any other physical or electronic means. It is not the intention of this application to limit the manner in which the code is stored, retrieved and used. It is anticipated that during the life of the patent, new techniques and devices for storing digital information will be developed.

The other starting point for the method is indicated at reference numeral 50 and comprises a database 50 of drugs that has been enhanced with sufficient granularity, 60, to take into account the gradations found in the factors shown, for example, at 10 in FIGS. 1 and 2. These parameters are correlated with drug dosages in the database 70 by a suitable algorithm. These parameters can include known or hereafter determined dosage variations that take into account the factors, among others, shown in FIG. 1, together with drug interactions and “do not dispense” instructions such as the penicillin allergy factor shown in FIG. 1. For example, a proposed prescription by a practitioner for penicillin or a close variant would be rejected outright based on the indication on the card 40 of a penicillin allergy without regard to the coding of the other factors. Similar rejections could occur if a drug known to be detrimental to kidneys in patients with abnormal kidney function was nevertheless prescribed. These rejections would offer the opportunity for the practitioner to revisit the diagnosis and prescribed drugs before prescribing or administration of the drug.

As shown in FIG. 2, the above method steps merge when a presenting patient is examined, 80. A diagnosis 90 results in a proposed prescription 100 by a practitioner. The card 40 is read as the practitioner is accessing the database 50 to determine the correct dosage of a particular drug at 110. The code card 40 is “read” either visually or digitally by means of a scanned bar code, Q-code, insertion of the code card 40 into a computer input device such as a USB port of by any other input means, 120. A dosage initially thought to be appropriate by the practitioner may be determined to be correct or it may be adjusted based on the codes on the code card 40, shown at 120. Alternatively, the practitioner may access the database with only a drug identified and the code card 40. In this instance, the algorithm of the database 50 determines the correct dosage in the first instance, 140.

One suitable manner by which this occurs is illustrated in FIG. 1. The code card 20 according to this example contains five discrete values determined to be specific to a particular patient. In the first code segment 21, the “2” may for example, indicate that the patient is between 6 months and 1 year old. In the second code segment 22, the “3” indicates that the patient has moderate renal impairment. The “2” in the code segment 23 indicates abnormal liver function. The “B” code segment 24 indicates that the patient has a genetic condition that requires adjustment of the dosage. The “B” or other indicated code segment is correlated in the drug database with a particular dosage adjustment. The “B” is purely arbitrary and may be any discrete designator. One genetic condition by itself may result in a modest increase or decrease in dosage or even a rejection. Another genetic condition may result in a completely different dosage adjustment or no adjustment at all. Finally, the “2” in code segment 25 indicates that the patient is allergic to penicillin, meaning that if the practitioner is considering a drug that contains penicillin or a derivative, the algorithm of the digital processor generates an alert and the proposed drug is rejected. The practitioner is therefore, presented with the opportunity to prescribe another antibiotic.

The code card 20 can adjust a prescription in the aggregate, meaning that, for example, an increase in dosage may be indicated in the code segment 21 for a very heavy patient and a countervailing decrease in dosage may be indicated for the same patient based on an indicated moderate renal impairment in code segment 22 and so forth. Based on consideration of all of the factors in the aggregate, the dosage may be increased, remain the same or decrease. Alternatively, the prescription may identify the drug and leave it to the code card 20 and the database digital processor to calculate the correct dosage in the first instance.

The code segments 21-25 are illustrative of the manner in which the invention is intended to function. Any number of code segments maybe selected and used in the general manner as described above. It is anticipated that as improvements in diagnosis practices and drug efficacy further develop and as digital storage, retrieval and display technologies change, the principles described in this application will be modified within the scope of the invention to keep pace with these developments.

A method of digitalizing, automating and personalizing medication drug ordering, prescribing and administration practices according to the invention have been described with reference to specific embodiments and examples. Various details of the invention maybe changed without departing from the scope of the invention. Furthermore, the foregoing description of the preferred embodiments of the invention and best mode for practicing the invention are provided for the purpose of illustration only and not for the purpose of limitation, the invention being defined by the claims.

I claim:

1. A method of personalizing drug dosages, comprising:
(a) analyzing and correlating a plurality of patient health condition factors specific to a particular patient with a database of drugs that includes drug dosage specifications and individual drug dosage adjustments based on the plurality of patient health condition factors;
(b) generating a code segment for each of the plurality of patient health condition factors specific to the particular patient;
(c) assigning the plurality of code segments to the particular patient;
(d) digitizing the plurality of code segments;
(e) storing the digitized plurality of code segments for retrieval in a digital processor;
(f) upon entry into the digital processor by a practitioner of a proposed drug prescription and a code segment for each of the plurality of patient health condition factors specific to the particular patient, retrieving the stored digitized plurality of code segments;
(g) reading the plurality of digital code segments specific to the particular patient;
(h) accessing the drug database;
(i) correlating the stored digitized plurality of code segments with the plurality of code segments specific to the particular patient; and
(j) adjusting the drug dosage as indicated by the output of the drug database.

2. A method according to claim 1, wherein the plurality of patient health condition factors comprise age, renal, liver, genomic and allergy.

3. A method according to claim 1, and including the step of determining an adjustment of a drug dosage based on the plurality of patient health condition factors in the aggregate.

4. A method according to claim 1, wherein the step of generating a code for each of the plurality of patient health condition factors comprises the step of assigning an arbitrary value to each of the plurality of factors independent of any other ones of the plurality of factors.

5. A method according to claim 1, wherein at least one of the plurality of patient health condition factors is a single factor that alone results in a rejection of the prescription.

6. A computer-assisted system for personalizing drug dosages, comprising:
(a) storing in a digital processor data identifying a plurality of drugs, drug dosage specifications and individual drug dosage adjustments based on a plurality of patient health condition factors;
(b) digitizing a plurality of code segments correlated to the plurality of drugs, drug dosage specifications and individual drug dosage adjustments based on a plurality of patient health condition factors;
(c) storing the digitized plurality of code segments in the digital processor for retrieval;
(d) receiving at the digital processor a proposed drug prescription including a code segment for each of the plurality of patient health condition factors specific to a particular patient;
(e) correlating in the digital processor the plurality of patient health condition factors specific to a particular patient with the stored digital data identifying a plurality of drugs, drug dosage specifications and individual drug dosage adjustments based on the code segments relating to the plurality of patient health condition factors; and
(f) outputting from the digital processor an adjusted drug dosage based on the correlation in (e).

7. A computer-assisted system according to claim 6, wherein the plurality of patient health condition factors comprise age/, renal, liver, genomic and allergy factors.

8. A computer-assisted system according to claim 6, wherein the digital processor determines an adjustment of a drug dosage based on the plurality of patient health condition factors in the aggregate.

9. A computer-assisted system according to claim 6, wherein the digital processor assigns an arbitrary value to each of the plurality of factors independent of any other ones of the plurality of factors.

10. A computer-assisted system according to claim 6, wherein at least one of the plurality of patient health condition factors is stored as in the digital processor as a single factor that alone results in a rejection of the prescription.

11. A computer-assisted system for personalizing drug dosages, comprising:
(a) storing in a digital processor data identifying a plurality of drugs, drug dosage specifications and individual drug dosage adjustments based on a plurality of patient health condition factors;
(b) digitizing a plurality of code segments correlated to the plurality of drugs, drug dosage specifications and individual drug dosage adjustments based on a plurality of patient health condition factors;
(c) storing the digitized plurality of code segments in the digital processor for retrieval;
(d) receiving at the digital processor a code segment for each of the plurality of patient health condition factors specific to a particular patient, wherein the plurality of patient health condition factors comprise age, renal, liver, genomic and allergy factors;
(e) assigning in the digital processor an arbitrary value to each of the plurality of factors independent of any other ones of the plurality of factors;
(f) accessing the digital processor with a proposed drug for a particular patient;
(g) correlating in the digital processor the proposed drug with the plurality of patient health condition factors specific to a particular patient and with the stored digital data identifying a plurality of drugs, drug dosage specifications and individual drug dosage adjustments based on the code segments relating to the plurality of patient health condition factors, wherein the digital processor determines an adjustment of a drug dosage based on the plurality of patient health condition factors in the aggregate; and
(h) outputting from the digital processor an adjusted drug dosage based on the correlation in (g).

12. A computer-assisted system according to claim 11, wherein at least one of the plurality of patient health condition factors is stored in the digital processor as a single factor that alone results in a rejection of the prescription.

13. A computer-assisted system according to claim 11, wherein a proposed drug includes the identification of a drug but does not contain dosage information and the digital processor correlates the plurality of patient health condition factors specific to a particular patient with the stored digital data identifying a plurality of drugs, drug dosage specifications and individual drug dosage adjustments based on the code segments relating to the plurality of patient health condition factors, wherein the digital processor determines a drug dosage based on the plurality of patient health condition factors in the aggregate.
